(19) United States
(12) Patent Application Publication
(10) Pub. No.: US 2009/0196417 A1
(43) Pub. Date: Aug. 6, 2009

(54) Secure disposal of storage data

(75) Inventors: Donald Rozinak Beaver, Pittsburgh, PA (US); Robert Harwell Thibadeau, Pittsburgh, PA (US)

Correspondence Address: SEAGATE TECHNOLOGY LLC;C/O WESTMAN, CHAMPLIN & KELLY, P.A., SUITE 1400, 900 SECOND AVENUE SOUTH, MINNEAPOLIS, MN, 55402-3244, US

(73) Assignee: Seagate Technology LLC

(21) Appl. No.: 12/012,260

(22) Filed: Feb. 1, 2008

(51) Int. Cl. H04L 9/08

(52) U.S. Cl. 380/45

(57) ABSTRACT

A data storage device (such as a magnetic disk drive), which has a built-in encryption function using a self generated cipher key. The data storage device uses the cipher key to routinely encrypt the incoming data without instruction and/or control by the host system or other components that are external to the device and its dedicated controls (e.g., a disk drive controller card). The encryption function is a built-in function or self-contained function of the drive and/or it dedicated controller. To permanently delete the entire content of the drive, the cipher key is located and erased to render the ciphertext that is stored in the storage device unusable. In another embodiment of the present invention, the data disposal is managed on a file basis through the use of a plurality of internally generated file-specific cipher keys, which are managed through the aid of an internal key library.

### FIELD OF INVENTION

The invention relates to data storage devices, and in particular to the secure disposal of data stored in data storage devices.

### BACKGROUND OF THE INVENTION

A conventional method for deleting a data file from a mass storage device, and in particular a hard disk drive, is to erase the file directory pointer that points to the storage blocks comprising the data file and to designate those storage spaces as available for new data. This approach renders the data file inaccessible by hiding it from the casual user. However, the storage blocks comprising the data file remain hidden on the storage medium until they are overwritten with new data. This is inherently dangerous because the user may believe that the data file has been deleted; yet a skilled intruder can use available software utility tools to scan for these “deleted” files, restore them and read them for sensitive information.

Attempts to provide a more secure method of file deletion usually involve deleting the file directory pointer and overwriting the storage space with 0's and 1's to remove any magnetic remnants of the deleted data. However, this method is relatively slow because the system must write 0's and 1's many times over a potentially large storage area to ensure that the stored information cannot be recovered from its residual magnetic information on the storage medium.

Another method of secure file deletion is to encrypt the stored data file using a cryptographic algorithm and one or more encryption/decryption keys (cipher keys). When permanent deletion of the encrypted data file is required, the file pointer and the associated decryption key(s) are erased so that the encrypted data (ciphertext) is rendered inaccessible. This method is quick because file deletion requires simply locating and destroying the file pointer and the decryption key(s) instead of overwriting the significantly larger encrypted data file. This method is secure because the remnants of the data file remain encrypted and permanently unrecoverable. However, this approach often relies on resources outside of the storage device to create, manage and destroy the cipher key(s). Using an external and potentially complicated key management system may expose the cipher key library to possible misuse by an unauthorized user, computer viruses or other types of malicious attacks.

The foregoing drawbacks in the prior art are exacerbated with the growth of unauthorized key logging hardware and software. These keystroke loggers are used to capture and compile a record of everything that the user types, including passwords, and making it available, sometimes over e-mail or via a web site, to the entity that is spying on the user. A key logging hardware and/or software may be used to compromise a cryptographic protection by capturing the passphrase that is used to externally generate the cipher key.

Therefore, what is needed is a storage device more securely encrypt and decrypt data and disposal of deleted data.

### SUMMARY

The present invention is directed to a novel data storage device (e.g., a magnetic storage device such as a disk drive) that internally generates a cipher key and uses it to encrypt incoming data then storing the resulting ciphertext on its storage medium. When the storage device receives a command to permanently delete the encrypted data, the cipher key is erased. The encrypted data becomes unusable and its storage space is made available for new data.

In one aspect of the present invention, a cryptographic processor located on the data storage device is used to internally generate a secret cipher key which is then stored in a secure location in the storage device (i.e. a secure storage space or nonvolatile memory) and is not made accessible outside the device. When the storage device receives new data, the storage device uses the cryptographic processor and the cipher key to encrypt the incoming data without instruction and/or control by the host system or components that are external to the device and its dedicated controls (e.g., a disk drive controller card). The encryption function is a built-in function or self-contained function of the device and/or its dedicated controller, which, in one embodiment, may include a mode in which the encryption function is configured to routinely (i.e., involuntarily and indiscriminately) encrypt incoming data regardless of the type, nature and/or source of such data, without requiring user or host device confirmation. The encrypted data is then recorded to the storage medium in the desired location. When the data is read, the ciphertext data is retrieved, decrypted and supplied to the user using the'same cipher key. If a user wants to permanently delete the entire content of the drive, the cipher key is located and erased to render the ciphertext that is stored in the storage device unusable. An intruder cannot use software utility tools to recover the data file because the ciphertext appears as a collection of random data bits with no discernable pattern. The storage device uses its cryptographic processor to generate a new cipher key and designates the previously occupied storage area as available for new data. The data disposal is managed on a drive basis, according to the requests of the drive owner or administrator, as opposed to managing the data disposal process using several keys held by various and potentially diverse “data owners” or “data originators.”

In another aspect of the present invention, the cryptographic processor may be used to generate a plurality of cipher keys for each storage device. For example, the storage area of a disk drive may be divided into a plurality of storage partitions and the storage device may use its cryptographic processor to generate a cipher key for each storage partition. The partition-key specific key is used to routinely encrypt incoming data prior to data storage, decrypt outgoing data prior to transmission, and as a way to quickly and securely erase a storage partition. In another embodiment of the present invention, the data disposal is managed on a file basis thorough the use of a plurality of internally generated file-specific cipher keys, which are managed through the aid of an internal key library.

### BRIEF DESCRIPTION OF THE DRAWINGS

For a fuller understanding of the nature and advantages of the invention, as well as the preferred mode of use, reference should be made to the following detailed description read in conjunction with the accompanying drawings. In the following drawings, like reference numerals designate like or similar parts throughout the drawings.

FIG. 1 is a schematic diagram of an exemplary networked servers and computing devices that use an internally generated cipher key and drive erasure scheme in accordance with the principles of the present invention.

FIG. 2 is a schematic representation of a disk drive that employs an internally generated cipher key and drive erasure scheme in accordance with the principles of the present invention.

FIG. 3 is a flow chart diagram showing the data writing process using an internally generated drive-specific cipher key as utilized by an embodiment of the present invention.

FIG. 4 is a flow chart diagram showing the data reading process using an internally generated drive-specific cipher key as executed by an embodiment of the present invention.

FIG. 5 is a flow chart diagram showing the secure drive erasure process through the deletion of the internally generated drive-specific cipher key as implemented by an embodiment of the present invention.

FIG. 6 is a flow chart diagram showing a data writing process using internally generated file-specific cipher key(s) as utilized by an embodiment of the present invention.

FIG. 7 is a flow chart diagram showing the data reading process using an internally generated file-specific cipher key(s) as executed by an embodiment of the present invention.

FIG. 8 is a flow chart diagram showing the secure data file erasure process through the deletion of the internally generated file-specific cipher key as implemented by an embodiment of the present invention.

### DETAILED DESCRIPTION

The present description is of the best presently contemplated mode of carrying out the invention. This description is made for the purpose of illustrating the general principles of the invention and should not be taken in a limiting sense. The scope of the invention is best determined by reference to the appended claims. This invention has been described herein in reference to various embodiments and drawings. It will be appreciated by those skilled in the art that variations and improvements may be accomplished in view of these teachings without deviating from the scope and spirit of the invention.

By way of illustration and not limitation, the present invention will be described in connection with a magnetic disk drive system that uses an onboard cryptographic processor to internally generate a cipher key that is used to encrypt incoming data, decrypt outgoing data and as a way to quickly and securely erase stored data. It will be appreciated that one or more general purpose or application specific processors may be present in the drive, which can be used individually or in combination to support the process of the invention. In addition, the present invention will be described in relation to a storage device that uses a separate cryptographic processor and a distinct memory unit in association thereto. It will be appreciated by those skilled in the art that the cryptographic processor and/or the memory unit may be integrated into one unit such as in a general-purpose microprocessor. It will also be appreciated that the drive of the present invention may be connected to and communicated with a host system through a standard interface such as IDE or through a network such as Ethernet in accordance with the principles of the present invention.

It is contemplated that the novel cipher key generation and drive erasure scheme of the present invention may be applied to other types of data storage systems, such as optical drives, high density floppy disk (HiFD) drives, etc., which may comprise alternative or in addition to magnetic data recording, other forms of data reading and writing, such as magneto-optical recording system, without departing from the scope and spirit of the present invention.

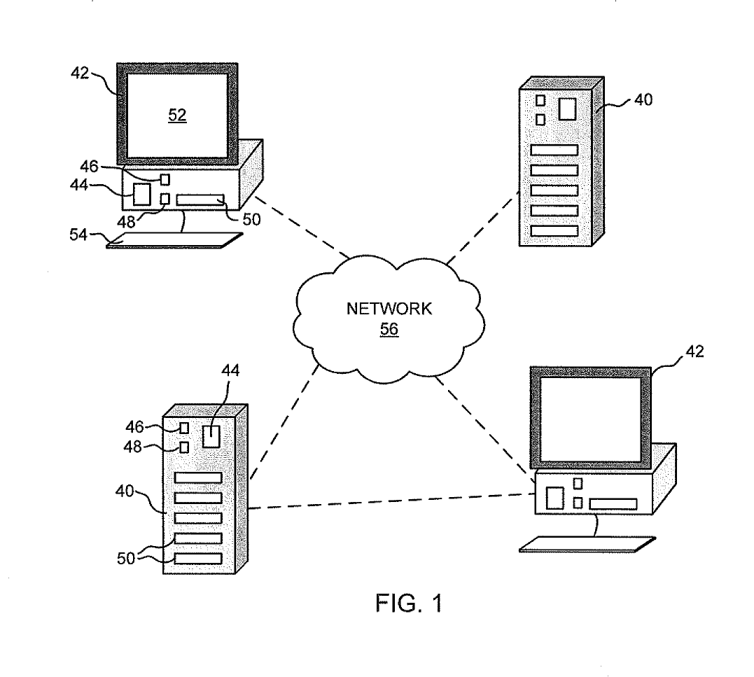

FIG. 1 is a block diagram of an example networked server 40 or computing device 42 that can use an internal key generation and data erasure scheme in accordance with this invention. A server 40 or computing device 42 is comprised of a processor 44, a volatile memory unit 46, a nonvolatile memory unit 48 and a mass storage device 50 in accordance with the present invention. The processor 44 may be coupled to the volatile memory unit 46 that acts as the system memory. An example of a volatile memory unit 46 is dynamic random access memory (DRAM). The processor 44 may also-be coupled to a nonvolatile memory unit 48 that is used to hold an initial set of instructions such as the system firmware. The processor 44 may be coupled to the mass storage device 50 that is used to store data files and instruction sets such as the operating system. The mass storage device 50 can be of any type or combination of types of a magnetic disk drive, a compact disk (CD) drive, a digital video disk (DVD) drive, a floppy disk drive, a Zip drive, a SuperDisk drive, a Magneto-Optical disk drive, a Jazz drive, a high density floppy disk (HiFD) drive, flash memory, read only memory (ROM), programmable read only memory (PROM), erasable programmable read only memory (EPROM), or electrically erasable programmable read only memory (EEPROM). The server 40 or computing device 42 may also include a video output device 52 such as a flat panel monitor to display information to the user, and an input device 54 such as a keyboard or a tablet to accept inputs from the user. The server 40 or computing device 42 may be connected to each other via a network 56 using wired and/or wireless connections. The server 40 or computing device 42 may also comprise of several processors 44, volatile memory units 46, nonvolatile memory units 48 and mass storage devices 50 each residing in different physical locations and are interconnected via a network 56 without departing from the scope of the present invention.

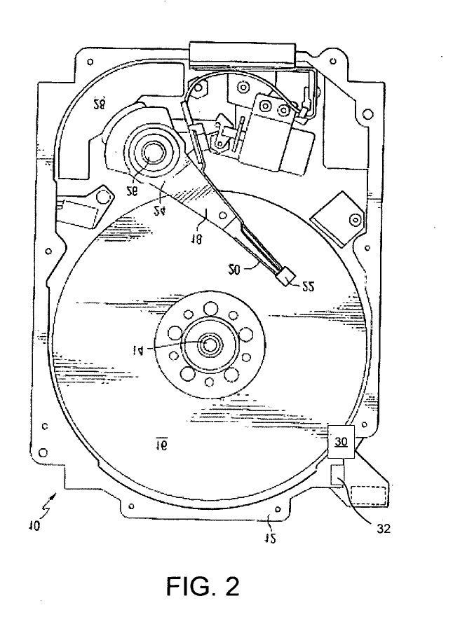

FIG. 2 is an illustration of an exemplary disk drive 10 (which may be used as drive 50 in FIG. 1) that can be used to implement the internal cipher key generation and data erasure scheme in accordance with this invention. The disk drive 10 includes a housing 12 (with the upper portion removed and the lower portion visible in this view) sized and configured to contain the various components of the disk drive. The disk drive 10 includes a spindle motor 14 for rotating at least one magnetic storage medium 16, which may be a magnetic recording medium, within the housing, in this case a magnetic disk. A suspension assembly having at least one arm 18 is contained within the housing 12, with each arm 18 having a first end 20 with a transducer in the form of a recording head supported on a slider 22, and a second end 24 pivotally mounted on a shaft by a bearing 26. An actuator motor 28 is located at the arm's second end 24 for pivoting the arm 18 to position the recording head 22 over a desired sector or track of the disk 16. A controller 30 is used to regulate the actuator motor 28 and other components, and may also be used to implement the cryptographic process and drive erasure scheme in accordance with the disclosure below. A memory unit 32 is used to permanently and/or temporarily stores a cipher key for use in the cryptographic process in accordance with the disclosure below.

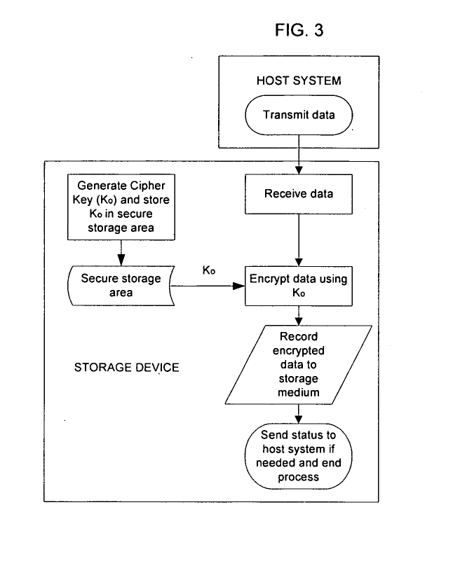

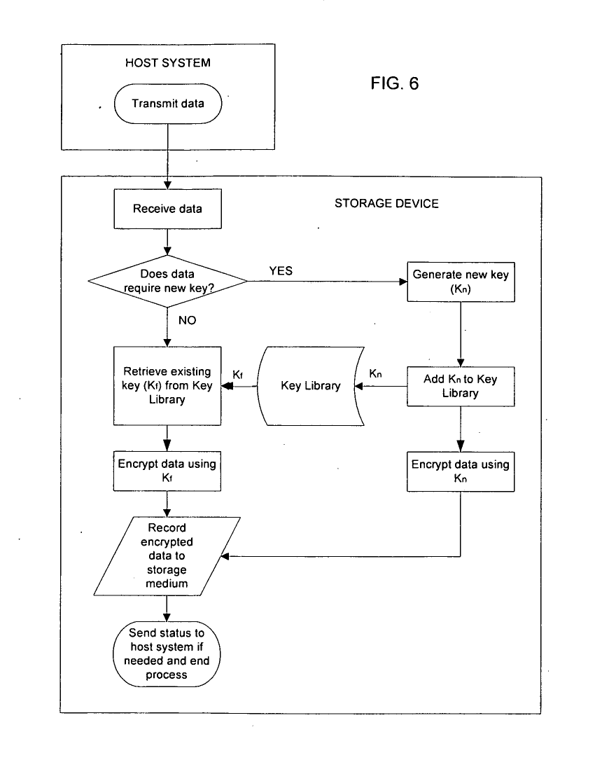

FIG. 3 is a flow chart diagram showing the data writing process using an internally generated drive-specific cipher key as utilized by an embodiment of the present invention. The storage device uses its onboard cryptographic processor, and uses, for example, a known process or the process illustrated in FIG. 6, to generate a cipher key K₀ in accordance with the Advanced Encryption Standard (AES). K₀ may be 128, 192 or 256 bits long and protected throughout the life of the stored data. K₀ may be protected by being kept in a secure area such as a secure storage area on the storage medium, or in a secure part of an onboard nonvolatile memory. The secure storage area is protected by known process such as making the storage area inaccessible to the user by hiding the storage area, encrypting the data content or removing the data reading privilege. The storage device may also protect K₀ by wrapping it with a different master cipher key that is internally generated by the cryptographic processor and uses the same or stronger encryption strength (i.e. bits length) than K₀ . The storage device may also keep a copy of K₀ in a volatile memory unit that is accessible by the onboard processor for use in encrypting and decrypting the incoming and outgoing data, respectively.

When a user wants to store new data on the storage device, the user utilizes the host system to transmit the data to the storage device. When a storage device receives new data from the host system, it uses its onboard cryptographic processor to encrypt the incoming data blocks using AES encryption algorithm and K₀ , and storing the resulting ciphertext on the storage medium. The storage device may send a status message back to the host system informing it that the data has been successfully saved and that the writing process is completed. Since K₀ is generated, stored, used and deleted internally by the storage device, it is never revealed to any outside parties. Therefore, the built-in key generation and cryptographic processes of the storage device remain hidden to the host system and the user. In addition, the key generation aspect of the present invention is completely self-contained and thus, is protected from malicious programs such as key logging software that exploit externally generated cipher keys by capturing the passphrase that is used to generate the cipher key.

In another embodiment, the encryption function may include a mode that can be preset by the user, to routinely (i.e., involuntarily and indiscriminately) encrypt all incoming data regardless of the type, nature and/or source of the data, without requiring confirmation by the user and/or host system to proceed with such encryption. In a further embodiment, the encryption function may be preset to perform encryption for all incoming data of a particular file type, nature (e.g., confidential personal data) and/or source (e.g., from a certain user or server).

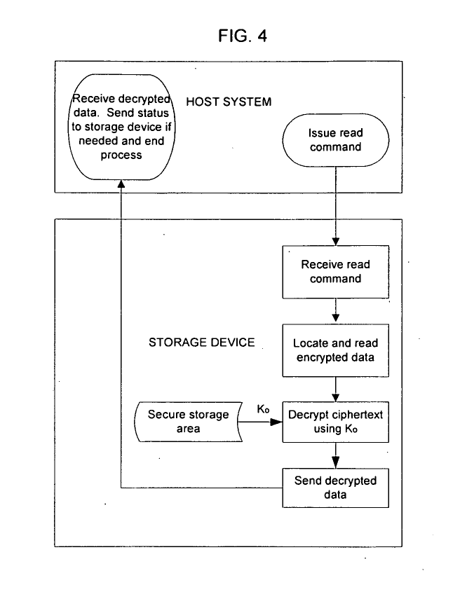

FIG. 4 is a flow chart diagram showing the data reading process using a drive-specific cipher key as executed by an embodiment of the present invention. When the host system needs to retrieve data from the storage device, it issues a read command to the storage device. The storage device receives the read command and proceeds to locate the stored ciphertext as directed by the read command. The storage device then uses the cipher key K₀ , which is stored in a secure storage area, to decrypt the ciphertext and returns the decrypted message to the host system. The storage device may also keep a temporary copy of the cipher key K₀ in its volatile memory unit for faster access by its cryptographic processor. The host system may send a status message back to the storage device informing it that the data has been successfully received by the host system and that the reading process is completed.

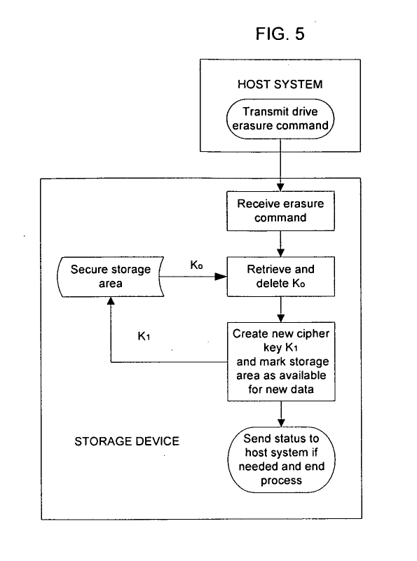

FIG. 5 is a flow chart diagram showing the secure drive erasure process by deleting the drive-specific cipher key as implemented by an embodiment of the present invention. When the storage device receives a permanent drive erasure command from the host system, the storage device locates K₀ from the secure storage area, including any temporary working copies that are stored in the volatile memory unit, and deletes them. This deletion renders the entire content on the storage device unusable since the cipher key needed to decrypt the stored ciphertext is no longer available. This process also allows secure drive erasure even if the drive is partially damaged. After the original cipher key is deleted, the storage device then generates a new cipher key K₁ and designates its entire storage area as available for storing new data.

In another embodiment of the present invention, the storage medium of the device is divided into a plurality of storage partitions. The storage device uses its onboard cryptographic processor to internally generate a cipher key for each partition and stores it in a secure storage area. When the storage device receives new data, it will refer to its file directory to determine the appropriate storage partition for the new data. The storage device will locate the appropriate partition-specific cipher key from the secure storage area, uses it along with the AES encryption algorithm to encrypt the new data, and stores the ciphertext in the correct storage partition. When the user needs to access the stored data, the user will send a read command through the host system to the storage device. The storage device receives the read command and retrieves the ciphertext from the storage partition. It then locates the correct partition-specific cipher key from the secure storage area and uses it to decrypt the data before transmitting the plaintext to the host system. The storage device may also keep a temporary copy of the cipher key in its volatile memory unit for faster access by its cryptographic processor. When the user wants to permanently erase the entire content of a storage partition, the user issues an erase command through the host system. The storage device receives the erase command, locates the appropriate partition-specific cipher key including any temporary copies in its volatile memory unit, and deletes them to render the ciphertext in the storage partition as unrecoverable. The storage device may send a status update to the host system and designate the “erased” partition as available storage area for new data.

Yet in another embodiment, the storage device will internally generate and use file-specific cipher keys in relation to a key library. When the storage device receives new data, it will determine using known process if the data is new or if it is a part of an existing data file. The storage device will then select an existing cipher key (for existing data file) from a key library that is stored in a secure storage area, or generate a new cipher key (for new data) to automatically encrypt the incoming data and store its ciphertext on the storage medium. When the operator needs to use the content of the encrypted data, the storage device retrieves the correct file-specific cipher key from the key library, uses the key to decrypt the data and transmits the decrypted data to the operator. The operator may quickly, securely and permanently delete the data by locating the file-specific cipher key and erases it to make the ciphertext useless.

FIG. 6 is a flow chart of an embodiment of the invention that uses an internally generated file-specific cipher key to automatically encrypt incoming data. The storage device receives a file from a host system such as a computer or a storage controller card. An onboard processor determines if the incoming data is a part of an existing stored data file or if it is a completely new data file by either using a built-in system memory that includes a file directory or by using location information transmitted by the host system. The file directory may also include an ID listing that associates each data file with its corresponding cipher key. If the incoming data is a new data file, the storage device will internally generate a file-specific cipher key Kₙ where Kₙ is generated by known processes in accordance with the Advanced Encryption Standard (AES). Kₙ may be 128, 192 or 256 bits long, and protected throughout the life of the stored data. Since Kₙ is generated internally by the storage device and is stored in a secure location on the storage device, the cipher key is not revealed to the user or anyone else. Using the cipher key, the storage device encrypts the new data file and records the resulting ciphertext on the storage medium. The cipher key Kₙ is then added to a key library that is located in a secure location on the storage medium (i.e. the disk drive platter or nonvolatile memory) and is not made accessible outside the drive. If the incoming data is part of an existing data file, the storage device will locate the corresponding file-specific cipher key K_{f} and uses it to encrypt the incoming data. The storage device will then record the resulting ciphertext on the storage medium.

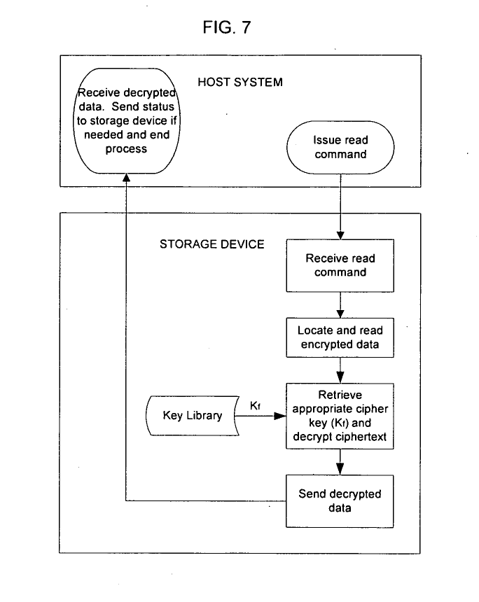

FIG. 7 is a flow chart diagram showing the data reading process using an internally generated file-specific cipher key stored in a key library, as implemented in accordance with an embodiment of the present invention. When the host system needs to retrieve a specific data file from the storage device, it issues a read command to the storage device. The storage device receives the read command and uses its file directory to locate the stored ciphertext. The correct cipher key is located from a key library, which is placed in a secure area on the storage medium, and uses it to decrypt the ciphertext. The correct cipher key K_{f} may be located through the use of an ID listing in the file directory that associates each data file with a specific cipher key. The decrypted message is then sent to the host system. The host system may transmit a status value to the storage device indicating that the message has been received.

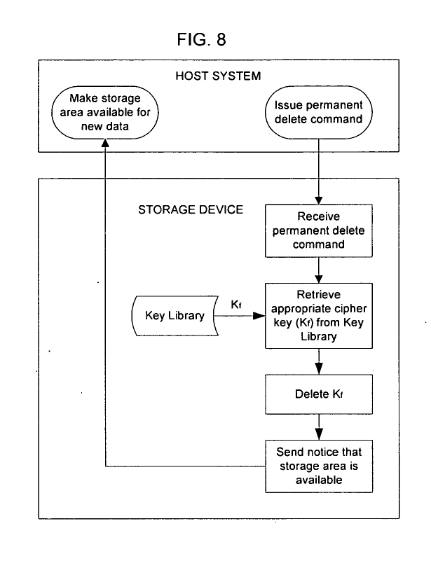

FIG. 8 is a flow chart diagram showing the secure data file erasure process through the deletion of the file-specific cipher key stored in a key library, as implemented in accordance with an embodiment of the present invention. When the storage device receives a permanent file erasure command from the host system, the storage device locates K_{f} from the secure key library, including any temporary working copy that is stored in the volatile memory unit, and deletes them. This deletion renders the encrypted data file on the storage device unusable since the cipher key needed to decrypt the stored ciphertext is no longer available. The storage device also deletes the file directory pointer and any associated cipher key ID to make available the storage area for new data.

In another embodiment of the present invention, the incoming plaintext message is not encrypted prior to storage. Instead, the plaintext message is temporarily stored on the storage medium in a specially designated cache storage area. The user may encrypt the plaintext message by issuing an encrypt command or allow the cryptographic processor of the present invention to routinely encrypt the plaintext at a later time when system resources are idle. The encrypted data is then stored in the appropriate location and the cache storage area is overwritten with either new plaintext or random data bits to remove the magnetic remnants of the plaintext. Alternatively, the incoming data may be designated for immediate encryption, later encryption or no encryption through the use of a flag or value that may reside in the data header or as a part of the data file. The flag may be the storage location, originating source, type or security level of the data file.

Yet in another embodiment of the present invention, the storage device may implement an authentication scheme to ensure the integrity of the commands and the data. The data integrity for a message can be assured using an authentication algorithm and authentication key. The authentication algorithm uses the message and the authentication key as inputs to calculate an authentication value. This authentication value is a short bit-string whose value depends on the authentication algorithm, the message and the key. One such authentication algorithm that can be used is the keyed hash function HMAC-SHA1. Alternative encryption and authentication algorithms will be clear to one skilled in the art. The authentication key may be internally generated by the storage device and shared with the host system through the use of a public key agreement scheme such as the Diffie-Hellman (DH) scheme. The DH scheme calculates and transmits a public reference number based on the original key value. Once the public reference number is received, the original key can be securely derived using known process.

Even though particular embodiments use a symmetric key system where the encrypting and decrypting algorithm uses similar keys, it will be appreciated by those skilled in the art that the invention may also use an asymmetric key system, a family of secret keys, and/or a family of secret keys may be derived from one or more master keys. In addition, the invention may use another encryption scheme besides AES such as Data Encryption Standard (DES) or triple DES to add uncertainty to the ciphertext.

Although particular embodiments of the present invention describe a storage device that uses a either drive-specific, partition-specific or file-specific cipher key(s) in its cryptographic and erasure processes, it will be clear to one skilled in the art that the invention may utilize individual or combinations of drive-specific, partition-specific and/or file-specific cipher key(s) for its cryptographic processes and as a way to rapidly and securely delete an entire storage device, a partition within the storage device, and/or a specific file stored in the storage device.

It is well contemplated that the novel cipher key generation and drive erasure scheme of the present invention may be applied to other types of data storage systems that use removable storage media, such as DVD−R, DVD−RW, DVD+R, DVD+RW, CD-ROM, high density floppy disk (HiFD) drives, etc. For example, the storage device derives a cipher key that is specific to the removable storage medium and stores that cipher key in a secure location in the storage device. As a result, the encrypted data on the removable storage medium cannot be accessed unless the removable storage medium is remounted on the originating storage device. If the storage medium falls into the hands of a malicious user, the storage medium can be remotely deleted through the erasure of its cipher key that is stored in the storage device.

While particular embodiments of the invention have been described herein for the purpose of illustrating the invention and not for the purpose of limiting the same, it will be appreciated by those of ordinary skill in the art that various modifications and improvements may be made without departing from the scope and spirit of the invention. For example, the key storage process of the present invention can be easily modified to accommodate the situation in which a key export scheme may be used in the recovery of accidentally deleted data. In this key export scheme, the onboard cryptographic processor and an internally generated master key may be used to encrypt the key library. The encrypted key library can be exported to another location for safekeeping and re-imported into the storage device for file recovery in case of accidental data deletion prior to the storage area being over written with new data. However, the cipher key generation and the cryptography processes are handled internally by the storage device.

The processes and associated steps discussed above for the various embodiments may be implemented by hardware, firmware and/or software physically located in the data storage device (e.g., implemented by a printed circuit board populated with active and passive electronic components), and/or its dedicated external controller (e.g., a control adapter card), and/or other device(s) that are dedicated or has a function dedicated to the data storage device, and that are physically, functionally and/or logically coupled to the data storage device to complete the system and processes in accordance with the present invention described above.

Useful devices for performing some of the operations of the present invention include, but is not limited to, general or specific purpose digital processing and/or computing devices, which devices may be standalone devices or part of a larger system. The devices may be selectively activated or reconfigured by a program, routine and/or a sequence of instructions and/or logic stored in one or more of the devices or their components. In short, use of the methods described and suggested herein is not limited to a particular processing configuration.

A method or process is here, and generally, conceived to be a self-consistent sequence of steps leading to a desired result. These steps require physical manipulations of physical and numerical quantities. Usually, though not necessarily, these quantities take the form of electrical or magnetic signals capable of being stored, transferred, combined, compared, and otherwise manipulated. It proves convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities.

The process and system of the present invention has been described above in terms of functional modules in block diagram format. It is understood that unless otherwise stated to the contrary herein, one or more functions may be integrated in a single physical device or a software module in a software product, or a function may be implemented in separate physical devices or software modules, without departing from the scope and spirit of the present invention. It will be further appreciated that the line between hardware and software is not always sharp.

It is appreciated that detailed discussion of the actual implementation of each module is not necessary for an enabling understanding of the invention. The actual implementation is well within the routine skill of a programmer and system engineer, given the disclosure herein of the process attributes, functionality and inter-relationship of the various functional steps in the process. A person skilled in the art, applying ordinary skill can practice the present invention without undue experimentation.

Accordingly, it is to be understood that the invention is not to be limited by the specific illustrated embodiments, but only by the scope of the appended claims.

1. A method of protecting data stored on a data storage device, comprising:
providing a cryptographic module in the data storage device;
receiving incoming data to be stored in the data storage device;
generating an encryption key by the cryptographic module for encrypting the incoming data;
encrypting the incoming data by the cryptographic module using the encryption key to generate ciphertext corresponding to the incoming data; and
storing the ciphertext in the data storage device.

2. The method of claim 1, wherein the encryption key is saved in a location in the data storage device.

3. The method of claim 1, further comprising receiving a data delete command by the data storage device with respect to stored ciphertext, and deleting the encryption key to render it permanently unavailable for decryption of the stored ciphertext.

4. The method of claim 1,
wherein different encryption keys specific to different data files stored in the data storage device are generated by the cryptographic module and stored in a key library in the data storage device, and
wherein the receiving step determines whether the incoming data is part of an existing data file already stored in data storage device, and (a) if the incoming data is part of an existing data file stored in the data storage device, the corresponding encryption key previously stored in the key library in the data storage device is retrieved from the key library, and the incoming data is encrypted using the retrieved encryption key, or (b) if the incoming data is not part of an existing data file stored in the data storage device, a new encryption key is generated by the cryptographic module for encrypting the incoming data.

5. The method of claim 1, wherein the cryptographic module routinely encrypts incoming data regardless of its type, nature and/or source, without requiring external confirmation.

6. The method of claim 1, wherein the cryptographic module encrypts incoming data of a particular file type, nature and/or source.

7. The method of claim 1, further comprising:
reading the ciphertext;
retrieving the encryption key; and
decrypting the ciphertext using the encryption key to generate plaintext corresponding to the prior stored incoming data.

8. The method of claim 7,
wherein different encryption keys corresponding to different data files stored in the data storage device are generated by the cryptographic module and stored in a key library in the data storage device, and
wherein the encryption key corresponding to a particular data file is retrieved from the key library.

9. The method of claim 7, wherein the encryption key is saved in a location in the data storage device, and the encryption is retrieved from the data storage device.

10. The method of claim 7, wherein the ciphertext is decrypted by the cryptographic module to provide corresponding plaintext to be output from the data storage device.

11. The method of claim 7, wherein upon receiving a data delete command by the data storage device with respect to stored ciphertext, deleting the encryption key to permanently prevent decryption of the stored ciphertext.

12. The method as in claim 1, wherein the data storage device comprises a magnetic data storage device.

13. A data storage system, comprising:
a data storage medium;
a transducer reading and writing data with respect to the data storage medium;
a cryptographic module protecting data stored on a data storage device, wherein the cryptographic module generates an encryption key to encrypt incoming data to generate corresponding ciphertext.

14. The data storage system of claim 13, wherein the encryption key is saved on the data storage medium.

15. The data storage system of claim 13, wherein the cryptographic module further decrypts the ciphertext using the encryption key to generate plaintext corresponding to the prior stored incoming data.

16. The data storage system of claim 15, wherein upon receiving a data delete command with respect to stored ciphertext, the encryption key is deleted to permanently prevent decryption of the stored ciphertext.

17. The data storage system of claim 15, further comprising a key library, wherein different encryption keys specific to different data files are generated by the cryptographic module and stored in the key library, wherein the encryption key specific to a data file is retrieved to decrypt ciphertext corresponding the data file.

18. The data storage system of claim 13, wherein the cryptographic module routinely encrypts incoming data regardless of its type, nature and/or source, without requiring external confirmation.

19. The data storage system of claim 13, wherein the data storage system comprises a magnetic disk drive including a magnetic data storage medium.

20. A data processing system, comprising:
a data storage system as in claim 13; and
a host system operatively coupled to the data storage system, said host system comprising a processor and an operating system, wherein the processor transfers data to and from the data storage system for read and write operations.
